(19) United States
(12) Patent Application Publication
(10) Pub. No.: US 2022/0080523 A1
(43) Pub. Date: Mar. 17, 2022

(54) AUTOMATIC MATERIAL RECOGNITION WITH LASER

(71) Applicant: TRUMPF Werkzeugmaschinen GmbH + Co. KG, Ditzingen (DE)

(72) Inventor: Anna Hoerner, Neulingen (DE)

(21) Appl. No.: 17/534,466

(22) Filed: Nov. 24, 2021

Related U.S. Application Data
(63) Continuation of application No. PCT/EP2020/061154, filed on Apr. 22, 2020.

(30) Foreign Application Priority Data
May 29, 2019 (DE) 10 2019 114 477.9

(51) Int. Cl. B23K 26/00; B23K 26/70

(52) U.S. Cl. CPC B23K 26/0006; B23K 26/707

(57) ABSTRACT

A method determines a material property of a workpiece to be processed by a laser processing machine or a machine property of the laser processing machine. The method includes: piercing the workpiece by a laser beam generated the laser processing machine; detecting a measurement variable at a piercing-through time; and determining the material property or the machine property by way of a correlation between the measurement variable and the material property or the machine property.

### CROSS REFERENCE TO RELATED APPLICATIONS

This application is a continuation of International Application No. PCT/EP2020/061154 (WO 2020/239328 A1), filed on Apr. 22, 2020, and claims benefit to German Patent Application No. DE 10 2019 114 477.9 filed on May 29, 2019. The aforementioned applications are hereby incorporated by reference herein.

### FIELD

The invention relates to a method for determining a material property of an, in particular planar, workpiece to be processed by means of a laser processing machine and/or a machine property of the laser processing machine.

### BACKGROUND

Workpieces of a wide variety of materials can be processed nowadays by means of laser processing machines. For optimum processing of the materials of which the workpieces consist, it is necessary in this case to set various parameters for the processing process. In this case, the parameters to be set are dependent, inter alia, on the material composition of the material to be processed and the material quality of the material, for example a carbon portion in a steel workpiece, or a material composition at the material surface, and the material thickness. If the quality of the material deviates from a target quality or a worker mixes up the material of the workpiece and the associated settings, then this may have comparatively great effects on the processing quality, such that consequential damage and/or consequential costs may arise, for example.

DE 10 2010 028 270 A1 and DE 39 18 618 A1 have previously disclosed a spectral analysis of the plasma during the piercing of a workpiece by a laser beam, in order thus to determine the material of the workpiece. However, such an analysis is comparatively complex and expensive and requires comparatively expensive supplementary equipment on a laser processing machine.

### SUMMARY

In an embodiment, the present disclosure provides a method that determines a material property of a workpiece to be processed by a laser processing machine or a machine property of the laser processing machine. The method includes: piercing the workpiece by a laser beam generated the laser processing machine; detecting a measurement variable at a piercing-through time; and determining the material property or the machine property by way of a correlation between the measurement variable and the material property or the machine property.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a laser processing machine in accordance with one embodiment;

FIG. 2 shows a flow diagram of a method in accordance with one embodiment using the laser processing machine in accordance with FIG. 1; and

FIG. 3 shows a schematic illustration of a laser power versus a piercing duration in the case of a method in accordance with FIG. 2.

### DETAILED DESCRIPTION

Aspects of the present invention remedying the aforementioned disadvantages of the prior art.

According to an aspect of the present invention, there is provided a method for determining a material property of an, in particular planar, workpiece to be processed by means of a laser processing machine and/or a machine property of the laser processing machine, wherein the workpiece is pierced by a laser beam generated by means of the laser processing machine, wherein a measurement variable is detected at a piercing-through time, and wherein the material property and/or the machine property are/is determined by way of a correlation between the measurement variable and the material property and/or the machine property. The workpiece can be for example a metal sheet and, in particular, a good part and/or a bad part.

According to an aspect of the present invention, the workpiece is pierced at a measurement point by means of the laser beam, specifically until a perforation is produced in the workpiece. The piercing-through time is reached when the laser beam perforates the workpiece. A measurement variable is detected at the piercing-through time, which measurement variable correlates with a material property of the workpiece and/or a machine property of the laser processing machine. The material property of the workpiece and/or the machine property of the laser processing machine can thus be deduced therefrom. The material property of the workpiece can accordingly be characterized by way of the measurement variable, without a comparatively complex and expensive spectroscopic examination having to be carried out.

The material property can be, in particular, a material composition, a material thickness, a cutting edge quality, and/or a material quality (surface property (e.g. oxidized or contaminated surface) or batch quality). The machine property can be for example a nozzle state (e.g. contaminated nozzle) or an optical unit state (e.g. heated or contaminated optical unit) of the laser processing machine.

In this case, aspects of the present invention are based on, inter alia, the following insight: If a laser beam of specific energy is directed up to a workpiece, a specific energy input is guided into the workpiece. Given sufficient laser intensity, the material melts or sublimates. The speed at which the material melts or sublimates is dependent, inter alia, on the respective energy input in a specific volume and the thickness of the workpiece. If the material is completely melted or sublimated, the light beam penetrates through the material. A measurement variable at the penetration time can thus provide information on a material property of the workpiece and/or a machine property of the laser processing machine.

The correlation between measurement variable and material property and/or machine property can be effected by way of a correlation model, for example by way of a mathematical/analytical model, an algorithm or a metamodel and/or artificial intelligence.

In this case, the workpiece can be planar or three-dimensional (e.g. deep-drawn component), provided that the piercing measurements are carried out on workpiece sections with (within the manufacturing tolerances) known workpiece thickness.

One advantageous development of the present invention provides for the measurement variable to be the piercing duration of the laser irradiation of the workpiece. In this case, the piercing duration is the time duration from the beginning of the laser irradiation of the workpiece until the penetration of the laser radiation through the workpiece at the piercing-through time. It is thus possible to measure the time duration during which the laser beam is incident on the workpiece. In this case, the piercing duration correlates in particular with various workpiece and machine parameters. By way of example, the piercing duration can correlate with the thickness of the workpiece at the measurement point, with the material composition at the measurement point and/or with the workpiece temperature. Furthermore, the piercing duration can correlate for example with the focus position of the laser processing machine.

If, for example, workpiece thickness (determined manually or by way of a sensor), focus position and workpiece temperature are previously known, then the material composition of the workpiece can be deduced on the basis of the piercing duration, for example by way of a mathematical/analytical model, an algorithm/a metamodel and/or artificial intelligence.

A correlation model can thus deduce an unknown parameter (e.g. material composition) from at least one, in particular a number of, known parameter(s) (e.g. workpiece thickness) of the processing system after measuring and taking account of the piercing duration.

The piercing duration in the case of constant machine parameters and material thicknesses is dependent, for various material compositions, in particular on the melting point, the material-dependent heat capacity, the thermal conductivity and the density, such that overall a material composition can be deduced therefrom. For this purpose, measurement series can be carried out in order to determine specific piercing durations for workpieces having known properties under known machine parameters and to develop a correlation model therefrom.

Overall, the time duration from the beginning of a measurement until the penetration of the laser through the workpiece at the piercing-through time can be correlated with the material composition of the workpiece, such that the material composition can be deduced from the piercing duration by way of a correlation model. Consequently, there is no need for an expensive sensor system, for example a spectroscopy sensor system, in order to ascertain the material composition. Rather, it is sufficient to determine the piercing duration and to deduce the material composition by way of a correlation model.

It would also be conceivable for the workpiece thickness at the measurement point to be deduced for example from a known material composition of the workpiece by way of a correlation model.

In a simple case, it would also be conceivable, given known model parameters and a known expected material composition, to deduce a material defect or an incorrect workpiece of the measured workpiece in the case of a deviation of a measured piercing duration from the expected piercing duration. A further advantageous configuration of the invention provides for a laser intensity of the incident laser beam to be increased by way of the duration of the laser irradiation of the workpiece. In this case, the power of the laser and the intensity of the emitted laser beam associated therewith can be linearly increased (ramped up). The intensity of the laser radiation can thus be increased by an absolute value x mW/s. Starting from a limit intensity the workpiece heats up in this case, so that the material of the workpiece either melts or sublimates (e.g. in the case of ultrashort pulse lasers). As a result, for example, the material composition can be deduced by means of the piercing duration by way of a correlation model. It is also conceivable, under certain circumstances, for the rise in the power and thus the laser intensity not to be linear with respect to time, which should then be taken into account in the correlation model. In this case, it would then be conceivable, for example, firstly to rapidly increase the laser power and to increase the latter more slowly starting from a specific limit power.

It is also conceivable for the measurement variable to be the laser intensity and/or a measurement variable characterizing the laser intensity at the piercing-through time. The power of the laser and/or the laser intensity at the penetration time correlate(s) directly with the energy input and thus the energy for melting or sublimating the material. This means that the absolute value of the energy of the laser at the penetration time can likewise correlate with a material or machine property. As a result, for example, the material composition of the workpiece can likewise be deduced on the basis of the intensity of the laser light and/or the power of the laser at the penetration time. In this case, in particular, the power of the laser and the intensity of the laser light associated therewith can once again be increased, for example linearly, by way of the piercing duration, wherein upon penetration the intensity of the laser light and/or the power of the laser are/is measured and assigned to the material property of the workpiece and/or to a machine property of the laser processing machine by way of a correlation model. The increase in the power/intensity over time can once again be linear (increase by X mW/s). Here, too, there is thus no need for expensive spectroscopy methods in order to ascertain the material of the workpiece. However, it is sufficient to measure the laser intensity and/or the laser power at the penetration time.

It would also be conceivable for the measurement variable to be the temperature at the piercing-through time and/or the energy input of the laser beam at the piercing-through time. In accordance with this embodiment, provision can thus be made of a sensor for measuring the temperature at the piercing-through time. In the case of such a sensor, it is thus possible to directly identify the temperature at the penetration time. Here, too, for example, the material composition of the workpiece and/or a machine property of the laser processing machine can be deduced by means of a correlation model. It would also be conceivable, on the other hand, to provide a sensor in order to measure the energy input of the laser beam at the piercing-through time. Accordingly, sensing of the energy input at the piercing-through time and correlation for determining the material composition of the workpiece and/or a machine property of the laser processing machine would be conceivable.

It is furthermore particularly preferred if a plurality of piercings are carried out, wherein a standard deviation and/or a variance of the measurement variable obtained are/is determined. It would also be conceivable to determine a measure equivalent to the standard deviation and/or to the variance. It is assumed here that the thickness of the workpiece in the measured region is constant or constant within the scope of the manufacturing tolerances. A standard deviation and/or a variance of the measurement variable obtained can thus be determined by way of a plurality of piercings at different measurement points of the workpiece. If the measurement variable is embodied as a piercing duration, then a variance/standard deviation of the piercing duration can thus be determined. Equally, in the case of ascertaining the laser beam intensity/laser power at the piercing-through time, a corresponding variance and/or standard deviation of the laser beam intensity/laser power can be determined. Finally, if the measurement variable is embodied as a temperature or as an energy input during piercing-through, a corresponding variance/standard deviation of the temperature/energy input at the piercing-through time can be determined.

In order to determine the type of material, it is also conceivable in this case, in a first step, firstly to increase the power of the laser by regulation comparatively rapidly over time and to store the measurement variable at the piercing-through time. For further measurements, the variance/standard deviation of the first measurement can then be delimited in order thus to ascertain the variance/standard deviation of the material by way of the combination of a first, fast measurement with slower subsequent measurements.

It is conceivable for a cutting edge quality to be deduced by way of the variance/standard deviation by way of a correlation model. In this case, a low variance/standard deviation can correlate in particular with a good cutting edge quality.

It is also advantageous if the difference between the determined measurement variables of two measurements is determined, and on the basis thereof an action is initiated if the difference exceeds a limit value. It is assumed here that the thickness of the workpiece is constant. Furthermore, it is assumed that the workpiece does not have global differences in material composition, but rather at most local differences, such that the deviation of the measurement variables with respect to one another should turn out to be comparatively small. It is thus possible firstly to determine a difference between the determined measurement variables (for example piercing duration, laser intensity/laser power at the piercing-through time, energy input/temperature at the piercing-through time). If this difference exceeds a limit value, for example an excessively large percentage deviation is present, then an action can be initiated on the basis thereof. The action may reside for example in making an operator aware of a problem by means of a message. However, it would also be conceivable for the action to reside in segregating the workpiece. Finally, it would be conceivable for an exceedance of the limit value not to be due to the material of the workpiece, but rather to parameters of the laser processing machine, for example, such that an exceedance of the limit value can also indicate a problem with the laser processing machine. In this case, the action could be maintenance work carried out e.g. by the laser processing machine or an operator in order to eliminate the problem. The maintenance work may be e.g. exchange of cutting gases, contaminated nozzle or optical unit, cooling water or other consumable material. Additionally or alternatively, it is also possible to carry out checking, cleaning and/or other work on apparatus parts of the laser processing machine, such as e.g. the drives, sensors.

Preferably, the piercing-through time is determined by detecting emitted and/or reflected light of the workpiece. Devices for detecting the piercing-through time are regularly already installed in laser processing machines. One possible method is disclosed in DE 10 2010 028 179 A1, for example, the disclosure content of which is fully incorporated in the present patent application. In this case, the process light generated is monitored during the piercing of the workpiece. The process light is the light emission from the hot workpiece if the latter is melted while being pierced by the laser radiation. In this case, the measurement intensity of the process light collapses when the workpiece is penetrated. This is because after passing through, the laser beam passes at least predominantly through the resulting perforation. However, it would also be conceivable to provide a back-reflection sensor system for measuring reflected laser radiation. In this case, too, the detected signal intensity of the reflected laser radiation collapses when the piercing-through time is reached and the laser radiation predominantly passes through the perforation. Monitoring of the process light is regularly used in the case of CO2 lasers. By contrast, in the case of solid-state lasers (for example fibre, disk, rod, diode) that emit in the near infrared, a back-reflection sensor system can regularly also be used. Such detection of when the piercing-through time is reached is possible comparatively simply, cost-effectively and reliably.

One particularly preferred development of the invention results from a method for processing a workpiece, the method comprising the following steps:
a. carrying out the method according to an embodiment of the invention for determining the material property of the, in particular planar, workpiece; and
b. calling up and setting at least one processing parameter of the laser processing machine on the basis of the determined material property in order to process the workpiece by means of laser radiation.

Firstly, a material property of the workpiece to be processed can thus be determined by means of the method according to an embodiment of the invention for determining the material property of the workpiece. As soon as the material property has been determined, the optimum cutting parameters—appropriate therefor—for the laser cutting of the material can be fed in, for example from a database, and can be adapted. The processing can thereupon be carried out with the optimum cutting parameters for the workpiece. A prerequisite for this, of course, is that a data set of the optimum parameters for the determined material is stored in the database. It would also be conceivable, for the multiplicity of materials present, to use an intelligent algorithm (AI) and/or a data analysis in order thus to obtain comparatively rapidly a material database in which the optimum cutting parameters for the respective material can be stored.

A further particularly preferred development of the invention results from a method for monitoring an, in particular planar, workpiece, the method comprising the following steps:
a. carrying out the method according to an embodiment of the invention for determining the material of the, in particular planar, workpiece; and
b. comparing the detected measurement variable with a reference value.

The monitoring makes it possible in particular to identify incorrect/defective workpieces and/or to ascertain contaminants in a material of the workpiece. By way of example, a lower quality of an alloy, for example an increased/decreased carbon content, leads to a change in the detected measurement variable. The reference value can thus constitute in particular a target value of the measurement variable if the material has a target composition. Depending on the configuration of the measurement variable, a deviation in the material composition can lead to a change in the piercing duration, the laser intensity/laser power at the piercing-through time, or the temperature at the piercing-through time or the energy input at the piercing-through time.

By way of example, the piercing duration may be known for a material having the target composition. If the intention is then merely to establish whether a sufficiently small deviation from the target composition is present, a piercing measurement can be carried out, for example. In this case, a ramp of the power of the laser can be y mW. This power can be x mW below the already determined laser power for penetrating the material of the workpiece. The laser power can then be increased by an absolute value z mW/s until the piercing-through time.

However, it would also be conceivable to increase the laser power firstly comparatively rapidly and then comparatively slowly by an absolute value x mW in the range of the expected laser power at the expected piercing-through time.

It is particularly preferred in this case if the method comprises the following further step:
c. initiating an action if the difference between the detected measurement variable and the reference value exceeds a limit value.

In this case, the action may reside for example in sorting out the workpiece if the detected deviation of the measurement variable from the target measurement variable exceeds a limit value. Exceeding the limit value can mean that the quality of the material is insufficient, for example on account of excessively large contaminants, or that an incorrect workpiece was selected.

However, it would also be conceivable for the cutting parameters during laser cutting to be adapted to the detected material. The cutting parameters can thus deviate from the cutting parameters in the case of a target composition of the material. Such an adaptation of the cutting parameters can also be carried out by way of an algorithm, for example. Artificial intelligence can also be used for this purpose.

Another aspect of the present invention provides a control device, embodied and configured for carrying out a method according to the invention.

Another aspect of the present invention provides a laser processing machine, comprising a control device according to the invention.

Further details and advantageous configurations of the invention can be gathered from the following description, on the basis of which the embodiment of the invention illustrated in the figures is described and explained in more detail.

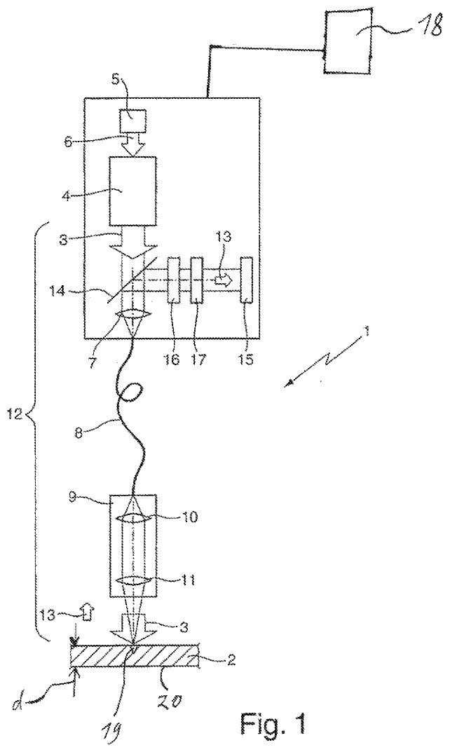

FIG. 1 shows a laser processing machine 1 used for the cutting of, in particular planar, workpieces 2, for example of metal sheets and, in particular, of good parts and/or bad parts, by means of laser radiation 3. To that end, the laser processing machine 1 comprises a laser source (solid-state laser) 4, for example of the yttrium aluminum garnet (YAG) type, which generates the laser radiation 3 with a laser wavelength suitable for laser material processing, for example in the range of approximately 1 μm, in particular for example of approximately 1.06 μm or of approximately 1.03 μm, and also a pump source 5—embodied by laser diodes for example—for pumping the laser source 4 with a pump radiation 6 suitable for the excitation thereof, such as 808 nm, for example.

The laser radiation 3 is coupled into an optical transport fibre 8 via an input coupling optical unit 7 and is guided in the fibre to a movable laser processing head 9 of the laser processing machine 1. Within the laser processing head 9, the laser radiation 3 is coupled out from the transport fibre 8 and is focused onto the workpiece 2 via a collimation optical unit 10 and a focusing optical unit 11. In the exemplary embodiment shown, these optical units 7, 10, 11 are illustrated merely by way of example as lenses. The beam path of the laser radiation 3 from the laser source 4 to the, in particular planar, workpiece 2 to be processed is designated in its entirety by 12. The collimation and focusing optical units 10, 11 arranged linearly one behind the other enable a design of the processing unit 9 that is linear in the direction of the optical axis.

The laser processing process and, in particular, the process in which the laser radiation 3 pierces the workpiece 2 are monitored by means of the visible process light 13 generated during the laser processing at the workpiece 2. The process light 13 and also the laser and pump radiations reflected at the workpiece 2 or at other optical surfaces pass along the beam path 12 back in the direction of the laser source 4.

An optical output coupling element in the form of a partly transmissive mirror 14 is arranged between the transport fibre 8 and the laser source 4, which mirror partly couples out the laser and pump radiations reflected at the workpiece 2 and also the process light 13 coming from the workpiece 2 and directs them onto a wavelength-sensitive detector (for example a photodiode) 15. The partly transmissive mirror 14 is arranged at 45° in the beam path 12 and is substantially transparent to the laser radiation 3 coming from the laser source 4. In the beam path of the process light 13 between the partly transmissive mirror 14 and the detector 15 there are arranged a laser radiation filter 16 and a pump radiation filter 17, which in each case transmit the process light 13 but not the laser radiation 3 and the pump radiation 6, respectively. This prevents the laser and pump radiations that are likewise coupled out by the partly transmissive mirror 14 from being able to swamp the process light signal to be evaluated. The pump radiation filter 17 can, in principle, also be arranged at any other location in the beam path of the process light 13.

As long as the process of piercing the workpiece 2 is not concluded, a comparatively high proportion of the process light 13 is generated at the workpiece 2. The proportion of process light 13 immediately decreases with the formation of a perforation in the form of a pierced hole, that is to say a laser beam exit at the underside of the workpiece.

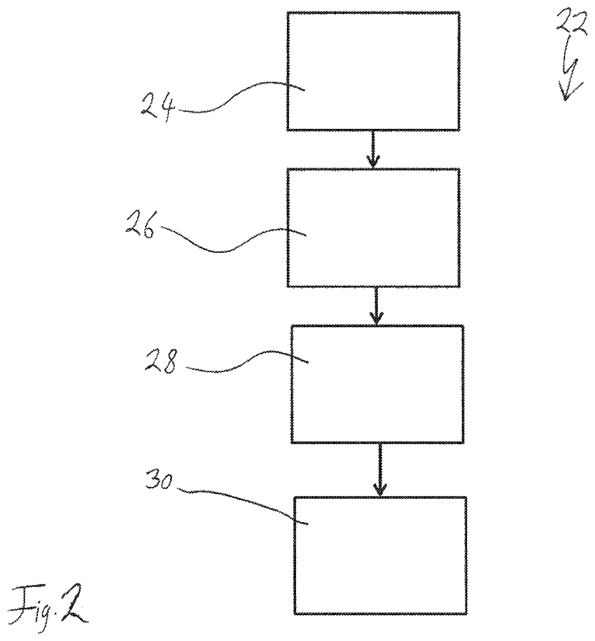

The laser processing machine 1 is then used for carrying out the method 22 shown in FIG. 2:

In order to find out the material of which the workpiece 2 consists, the thickness d thereof (cf. FIG. 1) is determined in a first step 24. This determination can be effected manually or automatically by way of a sensor. It would also be conceivable for the thickness d already to be previously known and stored in a control device 18 of the laser processing machine.

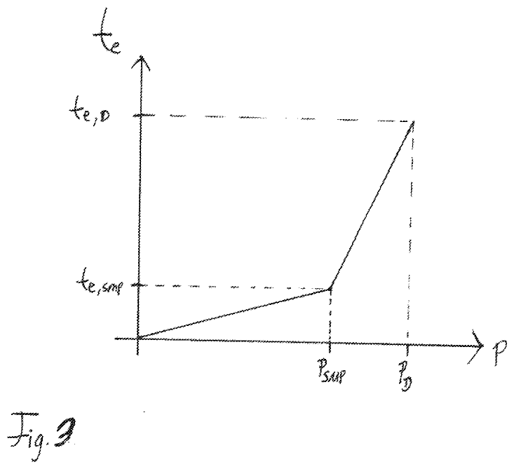

Then, in a next step 26, by means of the laser processing machine 1, a laser beam 3 is generated and the workpiece 2 is pierced at a measurement location 19. The focus position and focus size are kept constant in this case. The parameters of the cutting gas are also kept constant. However, the power of the laser and thus also the intensity of the laser are increased, in particular linearly, over the irradiation time. A certain energy input is thus introduced into the workpiece 2. As soon as the laser intensity is high enough, the material melts (cf. FIG. 3: Piercing duration t_{e,SMP} and laser power P_{SMP} at the melting point). In this case, the speed at which the material melts is dependent on the respective energy input in a specific volume. If the material is completely melted, then the laser beam penetrates through the material. As long as the process of piercing the workpiece 2 is not concluded, a comparatively high proportion of the process light 13 is generated at the workpiece 2. The proportion of process light 13 immediately decreases with the formation of a pierced hole, that is to say a laser beam exit at the underside 20 of the workpiece. In this case, step 26 involves measuring the piercing duration t_{e,D} for the piercing process (cf. FIG. 3). In this case, the piercing duration t_{e,D} is the time duration during which the laser radiation 3 acts on the workpiece 2 until the laser radiation 3 pierces through the workpiece 2, which is determined on the basis of the evaluation of the process light by means of the detector 15 of the laser processing machine 1. In this case, it is conceivable that, during a piercing process, the intensity of the laser is increased by an absolute value x mW/s and the time until penetration, that is to say the piercing duration t_{e,D}, is measured. In this case, the measurement begins as soon as the laser radiation 3 is incident on the workpiece 2.

In step 28, at least one item of user information can then be determined from the determined piercing duration by way of a model. The model can take account of known (processing) parameters and can determine an unknown parameter therefrom. Known parameters may be, in particular, the thickness d of the pierced-through workpiece section, determined in step 24, the workpiece temperature and/or the focus position. Furthermore, the piercing duration measured in step 26 is taken into account in any case. An unknown parameter can then be determined by way of a mathematical/analytical model, an algorithm/a metamodel or artificial intelligence. The unknown parameter may be, in particular, the material composition of the pierced-through workpiece section.

A correlation model can be created in particular by carrying out a number of experiments with workpieces having known material compositions and thicknesses and known processing parameters, the required piercing duration t_{e,D} being determined in each of the experiments.

The possibility of determining a material composition taking into account in particular the piercing duration and the material thickness becomes particularly clear on the basis of the example of metals: Pure metals have differences in their physical properties, for example differences in their melting points of approximately 2800° C. Magnesium melts at 648.8° C., while cerium melts at 3468° C. Metal alloys in turn have specific melting points. Altered compositions, for example an altered carbon content or contaminants, change the melting point. The difference in the temperatures of the pure metals (as mentioned above up to approximately 2800° C.) is so great that even slightly altered alloy compositions have different melting points. In this case, the melting point clearly defines a specific material. If the material is heated by laser radiation 3 at the melting point, this results in a penetration through the material by the laser. This means that known processing parameters (in particular the determined piercing duration and material thickness) permit conclusions to be drawn about the material composition of the workpiece 2.

If the material composition of a workpiece 2 is determined automatically in this way, then processing parameters can be called up by means of the control device 18 in step 30 in order to process the workpiece 2 by means of the laser processing machine 1 with optimum cutting parameters adapted to the material of the workpiece 2.

Conversely, it would also be conceivable, for example given a known material composition, to deduce a workpiece thickness d on the basis of the measured piercing duration by way of the correlation model.

In a simple case, it would also be conceivable firstly to pierce through at least one workpiece having a known material composition and a known thickness and to determine the piercing duration t_{e,D} until penetration. In this case, a plurality of measurements can be carried out in order to determine a mean value including a standard deviation/variance. This known material value can then be stored in a data set. In subsequent measurements, therefore, directly by way of the piercing duration t_{e,D} it is also possible to determine a deviation of the material composition of the workpiece 2 from a target material composition and thus to identify a material defect.

In this context, it is also possible for example to determine the quality of a workpiece 2 or to determine the presence of contaminants in the workpiece 2. This is because a material composition of the workpiece 2 which is different from that expected leads to a change in the piercing duration t_{e,D}. In this case, too, it is possible once again to carry out a plurality of measurements on the workpiece 2 in order to reliably determine a mean value with a standard deviation/variance. If a deviation in the material composition is determined, then either the workpiece 2 can be sorted out or an adaptation of the cutting parameters to the altered material composition can be carried out.

Overall, by means of the invention, from a measured piercing duration (given known parameters, such as a known workpiece thickness, for example), an unknown parameter, in particular a material composition, of the measured workpiece 2 can be deduced by way of a correlation model.

Consequently, in particular a material composition of a workpiece 2 can be determined simply and in a cost-effective manner automatically by means of the laser processing machine 1. As a result, the parameters for laser cutting can be adapted specifically to the determined material of the workpiece. Furthermore, a material mix-up or a deviation in the material quality from a target value can be determined, such that overall the processing quality can be increased and the probability of consequential damage and consequential costs can be reduced.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining a material property of a workpiece to be processed by a laser processing machine or a machine property of the laser processing machine, the method comprising:
piercing the workpiece by a laser beam generated the laser processing machine;
detecting a measurement variable at a piercing-through time; and
determining the material property or the machine property by way of a correlation between the measurement variable and the material property or the machine property.

2. The method according to claim 1, wherein the measurement variable is the piercing duration of the laser irradiation of the workpiece.

3. The method according to claim 1, wherein a laser intensity of the incident laser beam is increased by way of the duration of the laser irradiation.

4. The method according to claim 3, wherein the laser intensity is increased linearly over time.

5. The method according to claim 1, wherein the measurement variable is the laser intensity or a measurement variable characterizing the laser intensity at the piercing-through time.

6. The method according to claim 1, wherein the measurement variable is the temperature at the piercing-through time or the energy input of the laser beam at the piercing-through time.

7. The method according to claim 1, wherein a plurality of piercings are carried out, and wherein a standard deviation or a variance of the measurement variable obtained is determined.

8. The method according to claim 1, wherein at least two piercings are carried out, and wherein the difference between the determined measurement variables of two measurements is determined, and on the basis thereof an action is initiated based upon determining that the difference exceeds a limit value.

9. The method according to claim 1, wherein the piercing-through time is determined by detecting emitted or reflected light of the workpiece.

10. A method for processing the workpiece, the method comprising:
a. carrying out the method according to claim 1 for determining the material property of the workpiece; and
b. calling up and setting at least one processing parameter of the laser processing machine on the basis of the determined material property in order to process the workpiece by laser radiation.

11. A method for monitoring the workpiece, the method comprising:
a. carrying out the method according to claim 1 for determining the material property of the workpiece; and
b. comparing the detected measurement variable with a reference value.

12. The method according to claim 11, comprising:
c. initiating an action, in particular machine maintenance, based upon determining that the difference between the detected measurement variable and the reference value exceeds a limit value.

13. A control device, embodied and configured for carrying out the method according to claim 1.

14. A laser processing machine, comprising the control device according to claim 13.
